(19) United States
(12) Patent Application Publication
(10) Pub. No.: US 2006/0186367 A1
(43) Pub. Date: Aug. 24, 2006

(54) Butterfly valve

(75) Inventor: Norimitsu Kai, Miyazaki (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: ASAHI ORGANIC CHEMICALS INDUSTRY CO., LTD, Nobeoka-shi (JP)

(21) Appl. No.: 10/552,732

(22) PCT Filed: Mar. 4, 2004
(86) PCT No.: PCT/JP04/02707

§ 371 Date: Oct. 11, 2005

(30) Foreign Application Priority Data
Apr. 10, 2003 (JP) 2003-106830

(51) Int. Cl. F16K 1/22

(52) U.S. Cl. 251/305

(57) ABSTRACT

A butterfly valve includes a valve housing (1) having a substantially cylindrical flow passage formed therein, a disc-shaped valve element (4) arranged in the flow passage so as to be rotatable therein, a stem (3) extending from the valve element (4) to its outside and supported by the valve housing (1) so as to be rotatable, and an operating unit (8) for rotating the stem (3). The rotation of the stem (3) rotates the valve element (4) in the flow passage to open and close the flow passage. A top flange (2) for mounting the operating unit (8) is formed integrally with the valve housing (1). The top flange is formed with a plurality of cutouts (12) extending from the outer peripheral edge of the top flange toward the center thereof.

### TECHNICAL FIELD

The present invention relates to a butterfly valve used for a fluid transportation pipe line in various industries and, more particularly, to a butterfly valve which can be used at an end of a pipe and which has a structure that can be easily switched from manual to automatic mode or from automatic to manual mode, using the same valve housing, while being arranged in the pipe line.

### BACKGROUND ART

Generally, the on-off operation of the butterfly valve is performed in either manual or automatic mode by an operating unit connected to a stem of the butterfly valve. The operating unit includes a lever-type operating unit, a gear-type operating unit, an actuator, etc., of which the size and the pitch circle diameter of the mounting bolts are not uniform. Therefore, in the case where the mounting dimensions of the operating unit are different from those of the top flange of the butterfly valve, a valve housing having a top flange suitable for each operating unit has been prepared for a different purpose, or the top flange has been post-processed or a dedicated intermediate flange or joint has been used.

U.S. Pat. No. 5,564,461 proposes a butterfly valve shown in FIG. 7 as an example of a solution to this problem. In this butterfly valve, an intermediate flange 39 having cutouts 38 formed therein is interposed between a valve housing 36 and an automatic operating unit 37. The cutouts 38 of the intermediate flange 39 each engage a corresponding segment 43 having a male screw 41 and female screw 42 formed therein to fix the top flange 40 on the automatic operating unit 37. In the connecting process, the intermediate flange 39 is engaged with the segments 43 screwed on the automatic operating unit 37, and the segment 43 is screwed by several connecting bolts 44 with the intermediate flange 39 interposed between the top flange 40 and the automatic operating unit 37. Thus, a plurality of types of operating units having different mounting dimensions can be connected to the valve housing 36 by changing the male screws 41 and female screws 42 of the segments 43.

Japanese Examined Utility Model Publication No. 4-24218 proposes a butterfly valve shown in FIG. 8. In this butterfly valve, an intermediate flange 47 is interposed between a valve housing 45 and an automatic operating unit 46. The intermediate flange 47 is formed with holes through which mounting bolts 48 for fixing the automatic operating unit 46 and the intermediate flange 47 to each other are inserted and holes through which connecting bolts 50 for fixing the intermediate flange 47 and the top flange 49 to each other are inserted. In the connecting process, the mounting bolts 48 inserted through the intermediate flange 47 are fastened to the automatic operating unit 46 and the connecting bolts 50 inserted through the intermediate flange 47 are fastened to the valve housing 45 thereby to connect the automatic operating unit 46 and the valve housing 45 to each other. As a result, any of a plurality of types of the valve housing 45 and the operating unit can be combined with each other using a single intermediate flange 47.

The use of the butterfly valve having the structure described above eliminates the need of preparing a plurality of valve housings each having a top flange adapted for each driving unit to use any one of them for different purposes, post-processing the top flange or using a dedicated intermediate flange or joint, even if the mounting dimensions of the operating unit are different from those of the top flange of the butterfly valve. However, the conventional butterfly valve still has problems described below.

Firstly, the use of such a part as an intermediate flange or a joint increases the production cost as well as the product dimensions and deteriorates the production efficiency. Further, in the case where a joint is used, the operating unit and the stem may be displaced off-center from each other or a fitting failure may occur between the joint, the operating unit and the stem.

Secondly, in the case where a replacement space for mounting and demounting the operating unit is limited by the pipe flanges holding the butterfly valve when the butterfly valve placed in the pipe line is changed from manual to automatic mode or from automatic to manual mode, the bolts fixing the top flange and the operating unit are difficult to remove. Therefore, the butterfly valve is required to be removed from the pipe line.

Thirdly, when fixing the operating unit by inserting the bolts through the bolt holes formed in the top flange, the length of the housing neck and the stem supporting the valve housing and the top flange is required to be increased in order to avoid interference between the bolts and the lugs of the valve housing, thereby increasing the production cost. Further, the increased length of the housing neck concentrates the stress on the housing neck when mounting the heavy operating unit on the butterfly valve, and the strength of the valve housing may be affected. Also, the increased length of the stem increases the deflection of the stem when pressure is imparted to the valve element by the water supplied to the butterfly valve mounted in the pipe line, thereby probably affecting the stem strength. Further, the effect on the housing neck and the stem causes the deformation of the valve housing, etc., thereby decreasing the sealing performance and increasing the torque for the valve on-off operation. This is noticeable especially in the case where the valve is used so that only one side thereof is connected to the pipe or it is arranged at an end of the pipeline.

### DISCLOSURE OF THE INVENTION

The object of the present invention is to solve the above-mentioned problems of the prior art and to provide a butterfly valve having a structure in which a sealing performance is high and which uses the same valve housing to facilitate the switching from manual to automatic mode or automatic to manual mode.

According to the present invention, in order to achieve the above-mentioned object, there is provided a butterfly valve comprising a valve housing having a substantially cylindrical flow passage formed therein, a disc-shaped valve element arranged in the flow passage so as to be rotatable therein, a stem extending from the valve element to the outside of the valve housing and supported by the valve housing so as to be rotatable, and an operating unit for rotating the stem, the butterfly valve adapted so that flow passage is opened and closed by rotating the stem to thereby rotate the valve element in the flow passage, wherein said butterfly valve further comprising a top flange for mounting the operating unit thereon which is formed integrally with the valve housing, the top flange formed with a plurality of cutouts extending from the outer peripheral edge of the top flange toward the center thereof.

Preferably, the above butterfly valve further comprises an annular seat ring extending in a circumferential direction of the flow passage and fitted between the inner peripheral surface of the flow passage and the outer peripheral edge of the valve element, wherein the stem extends through the seat ring, the seat ring including a body and flanges formed at both axial ends of the body, the seat ring formed so that the outer periphery of the body thereof has an ellipse shape having a long axis extending along an axis of the stem and so that inner periphery of the body thereof has a circular shape.

More preferably, a groove for a spacer for preventing the stem from coming off to be fitted therein is formed on the upper surface of the top flange.

In the butterfly valve according to the present invention, a plurality of cutouts extending from the outer peripheral edge of the top flange toward the center thereof is formed on the top flange for mounting the operating unit thereon. Therefore, the pitch circle diameter of the connecting bolts for connecting the operating unit and the top flange to each other can be changed to the corresponding various pitch circle diameters. Further, the connecting bolts can be inserted into the cutouts from the outer peripheral edge of the top flange. Therefore, even if a space between the valve housing and the top flange is limited, the connecting bolts can be easily removed and the operating unit can be mounted and demounted easily.

Also, as the top flange is formed integrally with the valve housing, such parts as an intermediate flange or a joint separate from the valve housing are not required, and the off-center arrangement between the operating unit and the stem hardly occurs.

If a flange is formed on the body of the annular seat ring arranged between the inner peripheral surface of the flow passage and the outer peripheral edge of the valve element, the seat ring can be prevented from moving in the flow passage. Further, if the seat ring is formed so that the outer periphery of the body thereof has an elliptical shape having a long axis extending along an axis of the stem and so that the inner periphery of the body thereof has a circular shape, the inner periphery of the seat ring is in an elliptical shape when the seat ring is mounted on the inner peripheral surface of the substantially cylindrical flow passage. Thus, the sealing performance between the inner peripheral surface of the seat ring and the outer peripheral edge of the valve element is improved at the portion of the inner periphery of the seat ring through which the stem passes.

Also, if a spacer is mounted on the upper surface of the top flange, the stem is prevented from coming off when the operating unit is removed. Therefore, the operating unit can be changed safely.

The material of the valve according to the present invention may be a plastic such as polyvinyl chloride, polypropylene or polyvinylidene fluoride, or a metal, and is not especially limited.

### BRIEF DESCRIPTION OF THE DRAWINGS

The above and other objects, features and advantages of the present invention will be made apparent from the following detailed description of embodiments of the invention taken with reference to the accompanying drawings, in which:

FIG. 1 is a longitudinal sectional view of a butterfly valve having a lever-type operating unit mounted thereon according to the present invention;

FIG. 2 is a plan view of the butterfly valve of FIG. 1 with the lever-type operating unit removed;

FIG. 3 is a front view of the butterfly valve of FIG. 2 having a gear-type operating unit mounted thereon;

FIG. 4 is a front view of the butterfly valve of FIG. 2 having an automatic operating unit mounted thereon;

FIG. 5 is a longitudinal sectional view of a seat ring for use with the butterfly valve according to the present invention;

FIG. 6 is a partly cutaway perspective view of the seat ring for use with the butterfly valve according to the present invention;

FIG. 7 is an exploded perspective view showing a conventional butterfly valve connected with an operating unit; and

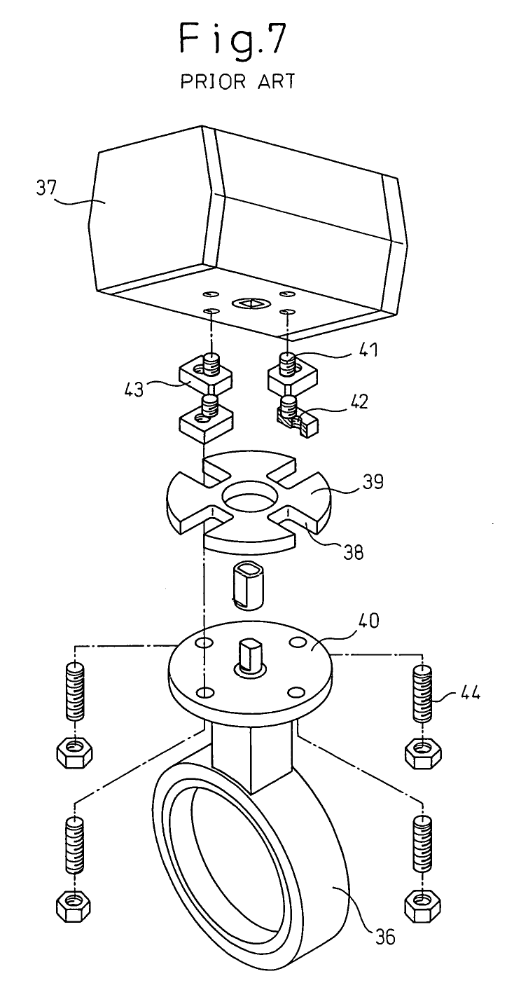

FIG. 8 is a front view showing a conventional butterfly valve connected with an operating unit.

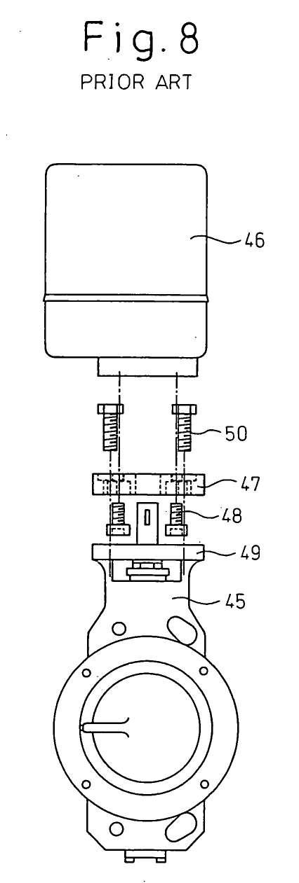

### BEST MODE FOR CARRYING OUT THE INVENTION

Embodiments of the present invention will be described below, with reference to the drawings, but the present invention is, of course, not limited to these embodiments.

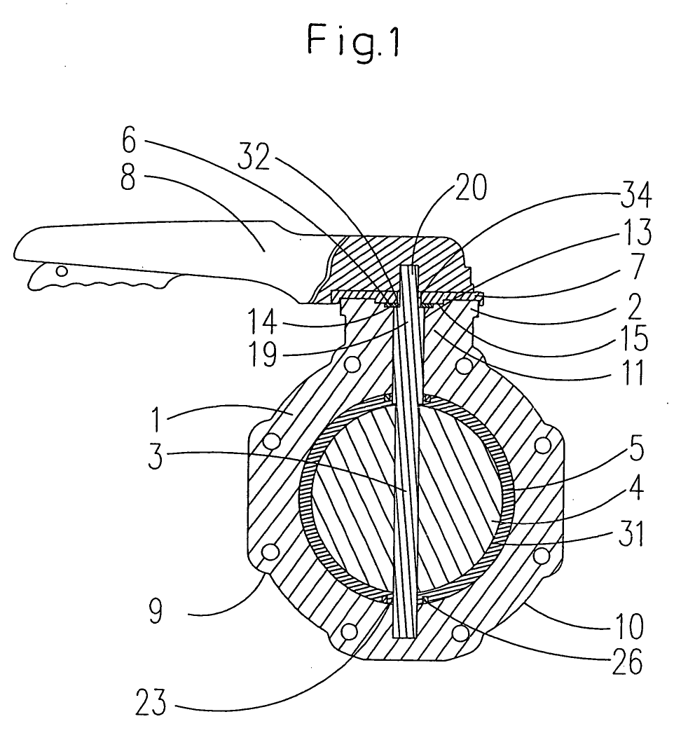

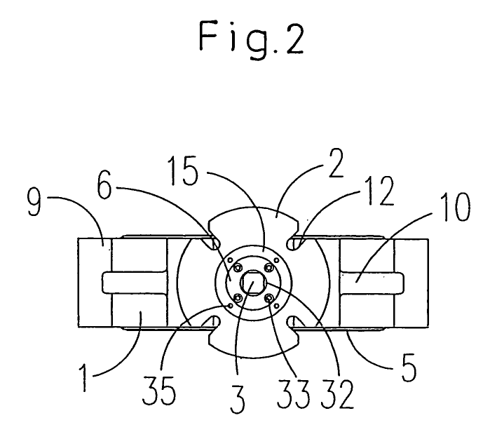

Referring to FIGS. 1 and 2, a butterfly valve includes a valve housing 1, a stem 3, a valve element 4, a seat ring 5, a spacer 6 for preventing the stem from coming off, and a locking plate 7.

The valve housing 1 is made of resin and, preferably, of polyvinyl chloride, polypropylene or polyvinylidene fluoride which are high in chemical resistance. A substantially cylindrical flow passage is formed in the valve housing 1, and a plurality of lugs 9 each formed with a bolt insertion hole for a piping bolt to be screwed are projected from the outer periphery of the valve housing 1. A thick flange-like base plate 10 is formed in the neighborhood of the cental portion of the outer periphery of the valve housing.

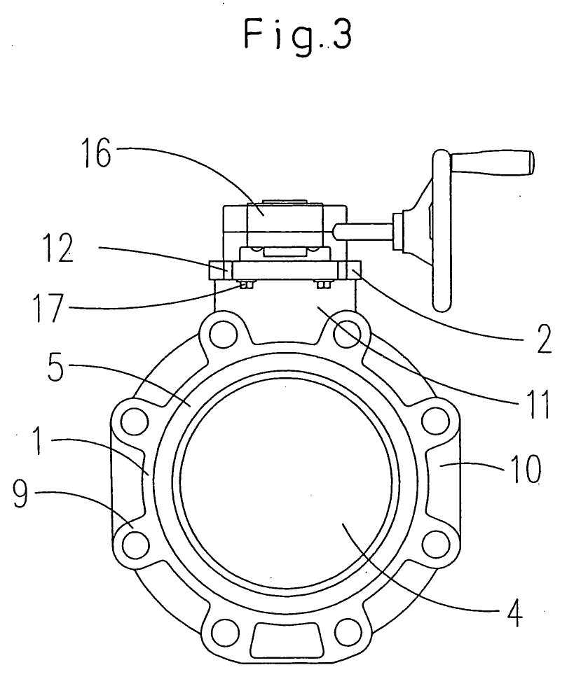

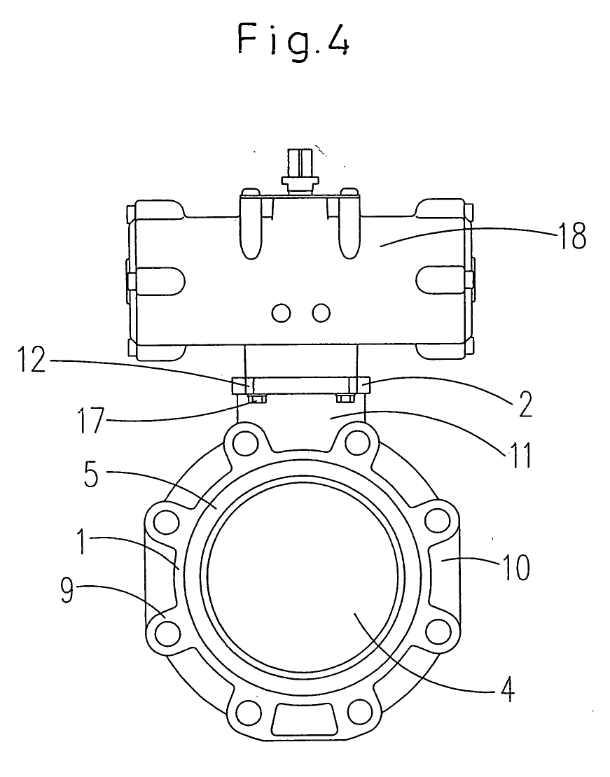

The top flange 2 has a disc-like shape and is formed integrally with the upper part of the neck 11 of the valve housing 1. A lever-type operating unit 8, a gear-type operating unit 16 (FIG. 3) or an automatic operating unit 18 (FIG. 4) is mounted on the top flange 2. The top flange 2 is formed with four cutouts 12 equidistantly around the center of the top flange 2 for fixing the gear-type operating unit 16 or the automatic operating unit 18 by connecting bolts 17 (FIG. 3).

These cutouts 12 are formed through from the upper end to the lower end of the top flange 2 to extend from the outer peripheral edge of the top flange 2 toward the center thereof. The inner end of each cutout 12 is terminated before reaching the stem through hole 13. Further, a groove 14 for fitting therein the spacer 6 for preventing the stem from coming off and a groove 15 for fitting therein the locking plate 7 required for mounting the lever-type operating unit 8 are formed at the central part of the upper surface of the top flange 2 so as to be different in level.

The stem 3 is made of SUS, and includes a stem body 19, and a reduced-diameter stem portion 20 located on the top of the stem body 19 and having a smaller outer diameter than the stem body 19. The upper end of the reduced-diameter stem portion 20 is arranged to be projected from the center of the top flange 2 provided at the upper portion of the valve housing 1, and is fixed on the lever-type operating unit 8 by bolts (not shown) with the upper end thereof extending through the through-hole 32 of the spacer 6 and through the through-hole 34 of the locking plate 7. The central portion of the stem 3 extends closely through the valve housing 1 and the seat ring 5 so as to be rotatable therein.

The valve element 4 is made of resin and has a disc-like shape. The valve element 4 is arranged at the central portion in the valve housing 1, and is fixedly mounted on the stem 3 rotatably extending through the central portion of the valve housing 1. Therefore, the valve element 4 rotates along with the rotation of the stem 3 in the seat ring 5 fitted in the valve housing 1, so that the outer peripheral edge of the valve element 4 is pressed against or separated from the inner periphery 27 of the seat ring 5 thereby to open and close the valve.

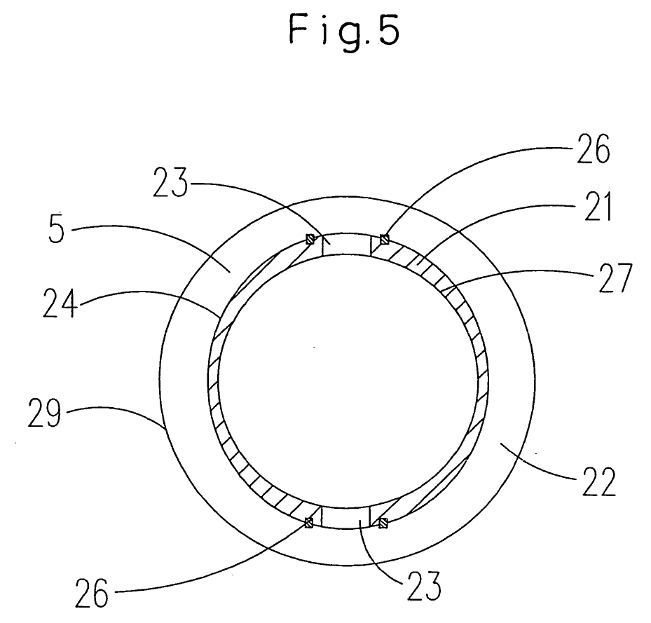

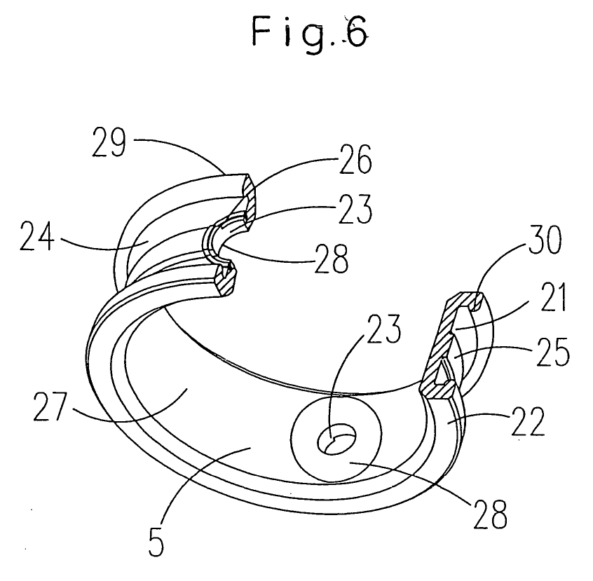

The seat ring 5 is made of elastomer or other elastic material and, as shown in FIGS. 5 and 6, includes a hollow cylindrical body 21, and flanges 22 integrally formed at both axial ends of the body 21. The cylindrical body 21 has a pair of stem through-holes 23 in diametrically opposed relation to each other for the stem 3 extending therethrough. The outer periphery 24 of the body 21 is formed in an elliptical shape having a long axis extending along a line connecting the two stem through-holes 23. In other words, the outer periphery 24 of the body 21 is formed so as to have the largest thickness along vertical direction connecting the two stem through-holes 23 and the smallest thickness along the horizontal direction orthogonal to the vertical direction.

The axial central portion of the outer periphery 24 of the seat ring 5 is formed with an annular protrusion 25 having a rectangular section. This annular protrusion 25 is fitted in the fitting groove formed on the inner peripheral surface of the valve housing 1 to prevent the axial movement of the seat ring 5. A ring 26 made of SUS is fitted on the peripheral surface of each stem through-hole 23 of the body 21. The inner periphery 27 of the seat ring 5, which the valve element 4 is pressed against or separated from, is formed so as to have a plane cylindrical surface. Further, the peripheral edge of each stem through-hole 23 is formed with a boss 28 having a spherical surface conforming to the shape of the valve element 4 to thereby improve the sealing performance of the valve seat. The outer periphery 29 of the flange 22 formed integrally with each axial end of the seat ring 5 is formed in a circular shape, and the lug 30 projecting inward from the outer end of each flange 22 is fitted on the outer peripheral surface of the valve housing 1 to prevent the movement of the seat ring 5.

The inner periphery of the opening 31 formed at the central portion of the valve housing 1 has a circular shape, while the outer periphery 24 of the seat ring 5 has an elliptical shape. Therefore, when the seat ring 5 is fitted in the valve housing 1, the flow passage defined by the inner periphery 27 of the seat ring 5 has an elliptical shape having a short axis extending in a direction along the stem axis connecting the stem through-holes 23. As a result, the inner periphery 27 of the seat ring 5 and the outer peripheral edge of the valve element 4 contact each other more closely near the stem through-holes 23 of the seat ring 5 than at the remaining portion, thereby making it difficult to develop leakage from the valve seat through the stem through-holes 23. On the other hand, in the portion other than near each stem through-hole 23, the proper sealing performance is maintained between the inner periphery 27 of the seat ring 5 and the outer peripheral edge of the valve element 4 and, therefore, the operating torque is not unnecessarily increased.

The spacer 6 for preventing the stem for coming off is made of resin and has a substantially disc-like shape. The central portion of the spacer 6 is formed with a circular through-hole 32 larger than the outer diameter of the reduced-diameter stem portion 20 and smaller than the outer diameter of the stem body 19. Four securing holes 33 are formed along a concentric circle around the through-hole 32 for securing the spacer 6 in the groove 14 of the top flange 2. The spacer 6 is inserted around the upper end of the reduced-diameter stem portion 20 projecting from the central portion of the top flange 2 so as to be rotatable, and is fixed by fastening means such as screws in the groove 14 formed at the upper end of the top flange 2 so that the spacer 6 presses the upper end surface of the stem body 19 downward.

The locking plate 7 is made of resin and has a generally disc-like shape. A circular through-hole 34 is formed at the central portion of the locking plate 7, and four fixing holes (not shown) are formed along a concentric circle around the through-hole 34 for fixing the locking plate 7 to the top flange 2. Also, a part of the outer peripheral edge of the locking plate 7 is provided with a stopper (not shown) for adjusting the opening degree of the valve. The locking plate 7 is fixed on the top flange 2 by passing the reduced-diameter stem portion 20 through the through-hole 34 with the spacer 6 held between the top flange 2 and the locking plate 7, inserting the screws through the fixing holes of the locking plate 7 and engaging the screws in the screw holes 35 of the groove 15 for fixing the locking plate 7.

Next, the operation of this embodiment of the valve will be described.

When the lever-type operating unit 8 in is rotated by 90 degrees from the fully closed state of the butterfly valve shown in FIG. 1, the stem 3 and the valve element 4 also rotate accordingly to thereby fully open the butterfly valve. When the lever-type operating unit 8 is rotated by 90 degrees in the reverse direction from the fully opened state of the valve, the outer peripheral edge of the valve element 4 is pressed against the inner peripheral surface 27 of the seat ring 5 to thereby fully close the butterfly valve.

When the butterfly valve is mounted in the pipe line, the piping bolts are screwed into the lugs 9 with both sides of the valve housing 1 held by the pipe flanges. The lugs 9 are formed with female screws for engaging the piping bolts and, therefore, the butterfly valve can be used even if it is connected to the pipe at only one side thereof, i.e. it is arranged at an end of the pipe line.

When the operating unit is replaced, the pitch circle diameter of the connecting bolts 17 can be changed to the corresponding pitch circle diameter by moving the connecting bolts 17 in the radial direction of the top flange within the length of the cutouts 12. Also, the width of the cutout 12 (i.e. the size of the cutout 12 in the direction perpendicular to the length thereof) is set to such a size that the head of the connecting bolt 17 for connecting the operating unit to the top flange 2 is in contact with and supports the lower end of the top flange 2. Thus, the connecting bolts 17 of various sizes can be used within the width of the cutouts 12.

In the connecting process, the stem 3 projecting from the central portion of the top flange 2 is fitted in the fitting portion of the operating unit. The operating unit is formed with bolt holes in which the connecting bolts 17 are inserted. The connecting bolts 17 are inserted into the corresponding cutouts 12 from the outer peripheral edge of the top flange 2 and, after the position of each connecting bolt 17 is adjustably changed to a position corresponding to the position of the corresponding bolt hole of the operating unit, the connecting bolts 17 are inserted into the corresponding bolt holes. After insertion, the connecting bolts 17 are fastened to connect the operating unit to the top flange 2.

In this way, the connecting bolts 17 can be moved in a radial direction of the top flange 2 within the length of the cutouts 12 in accordance with the pitch circle diameter of the operating unit, and the size of the connecting bolts 17 can be changed within the width of the cutouts 12. Further, the cutouts 12 open outward at the outer peripheral edge of the top flange 2, and the connecting bolts 17 can be inserted into the bolt holes of the operating unit from the outer peripheral edge of the top flange 2. Therefore, even if the valve housing 1 is held by the pipe flanges and the replacement space available for replacing the operating unit is limited, the connecting bolts 17 can be easily removed and the operating unit can be replaced by any arbitrary type of operating unit, for example, a manual type or an automatic type, in accordance with the intended application.

FIG. 3 is a front view of the butterfly valve shown in FIG. 2 having a gear-type operating unit 16 mounted thereon. When the gear-type operating unit 16 is mounted on the butterfly valve, the reduced-diameter stem portion 20 projecting from the top flange 2 is inserted into the fitting portion of the gear-type operating unit 16 so that the positions of the bolt holes of the gear-type operating unit 16 are aligned the positions of the cutouts 12, and the connecting bolts 17 are then inserted into the cutouts 12 of the top flange 2 to engage the connecting bolts 17 in the bolt holes of the gear-type operating unit 16.

FIG. 4 is a front view of the butterfly valve shown in FIG. 2 having an automatic operating unit 18 mounted thereon. This embodiment is different from the embodiment shown in FIG. 3 in that the automatic operating unit 18 is mounted on the butterfly valve instead of the gear-type operating unit 16. The cutouts 12 of the top flange 2 make it possible to fix the automatic operating unit 18 on the top flange 2 by the connecting bolts 17 even if the pitch circle radius of the bolt holes of the automatic operating unit 18 is different from that of the gear-type operating unit 16. As the other points are the same as in the case shown in FIG. 3, a description thereof will be omitted.

As explained above, in the butterfly valve fabricated in accordance with the present invention, the top flange formed with the cutouts for mounting the operating unit is formed integrally with the valve housing, resulting in beneficial effects as described below.

(1) Actuators or gear-type operating units of different mounting sizes can be mounted on the same valve housing, and a compact product can be fabricated at low cost without using any additional parts such as the spacer or the joint used in the prior art. Further, the possibilities of either an off-center arrangement between the operating unit and the stem or a fitting failure between the joint, the operating unit and the stem, due to the use of the joint, can be eliminated.

(2) As the connecting bolts for fixing the top flange and the operating unit to each other can be easily removed with the butterfly valve connected to the pipe line, the operating unit can be mounted or demounted without removing the butterfly valve from the pipe line, and the butterfly valve can be freely and easily switched from manual to automatic mode or from automatic to manual mode in accordance with the intended application. Further, in view of the fact that the spacer for preventing the stem from coming off is screwed on the top flange of the valve housing, the stem can be prevented from coming off when removing the operating unit and, therefore, the operating unit can be replaced safely.

(3) The bolts for fixing the operating unit do not interfere with the lugs of the valve housing when the operating unit is mounted or demounted on or from the top flange. Therefore, the body neck and the stem can be designed to be smaller, thereby making a low-cost production possible. Also, the shorter body neck and stem and the stronger valve housing suppresses the deformation of the valve housing, thereby alleviating the problem of a deteriorated sealing performance or an increased torque in the valve on-off operation. Further, the use of the elliptical seat ring prevents the operating torque from increasing, and makes it difficult for leakage to occur from the valve seat near the stem through-holes. Also, the possibility of the leakage from the valve seat in the direction perpendicular to the stem axis and the internal leakage from the stem through-holes can be reduced, resulting in the beneficial effect that the valve can be used in a stable state for a long time even if the valve is used so that only one side thereof is connected to the pipe.

Although the several embodiments of the present invention shown in the accompanying drawings have been described above, these embodiments are only illustrative but not limitative. The scope of the present invention is defined by the appended claims and, therefore, the embodiments described above can be changed or modified without departing from the scope of the claims.

1. A butterfly valve comprising a integrally formed valve housing having a substantially cylindrical flow passage formed therein, a disc-shaped valve element arranged in said flow passage so as to be rotatable therein, a stem extending from said valve element to the outside of said valve housing and supported by said valve housing so as to be rotatable, and an operating unit for rotating said stem, said butterfly valve adapted so that said flow passage is opened and closed by rotating said stem to thereby rotate said valve element in said flow passage,
wherein said butterfly valve further comprises a top flange for mounting said operating unit thereon by connecting bolts, which is formed integrally with said valve housing, said top flange formed with a plurality of cutouts extending from the outer peripheral edge of said top flange toward the center thereof so that said connecting bolts can be moved in said plurality of cutouts in a radial direction of said top flange.

2. The butterfly valve according to claim 1, further comprising an annular seat ring extending in a circumferential direction of said flow passage and fitted between the inner peripheral surface of said flow passage and the outer peripheral edge of said valve element, wherein said stem extends through said seat ring, said seat ring including a body and flanges formed at both axial ends of the body, said seat ring formed so that the outer periphery of said body thereof has an elliptical shape having a long axis extending along an axis of said stem and so that the inner periphery of the body thereof has a circular shape.

3. The butterfly valve according to claim 1, wherein a groove for a spacer for preventing said stem from coming off to be fitted therein is formed on the upper surface of said top flange.

4. The butterfly valve according to claim 2, wherein a groove for a spacer for preventing said stem from coming off to be fitted therein is formed on the upper surface of said top flange.

5. The butterfly valve according to claim 1, wherein said drive operating mounted on said top flange comprises a manual operating unit.

6. The butterfly valve according to claim 5, wherein said manual operating unit comprises a lever-type operating unit or a gear-type operating unit.

7. The butterfly valve according to claim 1, wherein said operating unit mounted on said top flange comprises an automatic operating unit using an actuator.
